(19) United States
(12) Patent Application Publication
(10) Pub. No.: US 2005/0218239 A1
(43) Pub. Date: Oct. 6, 2005

(54) Mobile communication terminal with humidity sensor

(76) Inventor: Georg Busch, Ahaus (DE)

Correspondence Address: BELL, BOYD & LLOYD, LLC, P. O. BOX 1135, CHICAGO, IL, 60690-1135, US

(21) Appl. No.: 10/503,159

(22) PCT Filed: Jan. 2, 2003
(86) PCT No.: PCT/DE03/00002

§ 371 Date: Jul. 30, 2004

(30) Foreign Application Priority Data
Jan. 31, 2002 (DE) 102 03 815.5

(51) Int. Cl. G05D 23/00

(52) U.S. Cl. 236/47

(57) ABSTRACT

A mobile communication terminal with a processor control is disclosed, wherein the terminal includes at least one independent humidity sensor controlled by the processor to detect humidity for the purpose of reducing or preventing corrosion in the mobile communication terminal. Upon detection of humidity, either a complete or partial shut down of the mobile communication terminal is effected. In particular, during a partial shut down, those components necessary for detection of humidity and for reactivating the mobile communication terminal remain active. Additionally, functional components are protected from corrosion by reducing voltage differentials when humidity is detected.

### BACKGROUND

The present disclosure relates to a mobile communication terminal and, more particularly, a mobile communication terminal including a processor control for handling of particular functions and a humidity sensor.

Repeatedly, mobile communication terminals show signs of corrosion in the interior of the housing on metallic, electrically unprotected connections and surfaces. Complaints by customers about their mobile communication terminals are to a large extent based upon such signs of corrosion.

The keypad surfaces are particularly, but not exclusively, affected by the signs of corrosion. In cases where the communication terminal is incorrectly handled under normal environmental conditions, such as in a household, short-circuits through corrosion products frequently ensue in the area around components. These short-circuits occur when the device is switched on and where there are voltage differentials in the order of 1.2 volts and above between two electrically active potential points having a spacing less than or equal to that above which electrolysis no longer takes place. An example of a spacing above which electrolysis no longer takes place might be 2 cm. The magnitude of the voltage differential ultimately depends on the actual prevailing conditions. An example of incorrect handling of the communication terminal under normal environmental conditions in a household might be the dropping of the communication terminal in a bucket containing water mixed with some conventional household cleaning agent.

In devices with rubber mats and/or films, in particular, signs of corrosion can be observed below the rubber mat or film on unprotected electrically conductive metallic surfaces.

If an aqueous liquid reaches a module with an operating voltage of greater than 1.2 volts, then, as a result of electrolysis, the liquid becomes strongly alkaline, up to a pH value of 14. In a short time the alkaline liquid will destroy the module through corrosion. Impurities on the module can further accelerate this process. In cases where more recent solders composed of tin/silver/copper are used, this process is accelerated even more. Acidic liquids can also cause corrosion to occur.

In order to counteract corrosion, splash-proof devices, for example, have been utilized. However, even devices using those splash-proof devices are not immune to corrosion. Over time, corrosion also occurs in these devices (e.g., on contact surfaces in the keypad).

It is also known to stem corrosion through the application of protective lacquers before devices are assembled. A disadvantage with such lacquers is that only limited repairs to modules are then possible. A further disadvantage is that the contact points of keypads cannot be protected in this way, because they would otherwise be insulated and, as a result, non-functional. The use of dip varnishing is also known where no contact surfaces have to be taken into consideration.

The use of carbon on the key contacts and test points is also known, for the purpose of preventing corrosion in devices. Using carbon for protection against corrosion is not possible in a large number of devices, however, because of the packing density of the components.

It is also known for contact surfaces to be designed with a generously large surface area in order to delay the effects of corrosion, for example in the form of a break in the contacts. On the whole, however, corrosion cannot be prevented in this way, at least not fully. It is equally difficult to prevent the expansion of a short-circuit caused by corrosion products.

In addition, it is known to provide a mobile communication terminal with a humidity sensor wherein values measured by the sensor can be displayed in the display and the communication terminal. Additionally, modern mobile communication terminals, as a rule, include a processor control. Thus, it can implicitly be assumed that such known communication terminals have such a processor control. The humidity sensor in these devices provides an additional function for the communication terminal. The humidity sensor and the additional function it provides do not have an functional relationship to the communication terminal itself, however. While it is possible for the values measured by the humidity sensor to be called up in the communication terminal's display, the existence of such values does not, in itself, affect the functions of the communication terminal. The humidity sensor is merely one of many possible additional components considered that are built into the communication terminal. Such additional components, with their respective associated additional functions in the communication terminal, subsequently have an advantage that the components are always on hand because, while people rarely forget the communication terminal, they would often forget a separate component with the additional functions concerned in each case.

It is therefore not a question here of a symbiosis between the additional component with a particular additional function concerned and the communication terminal itself, but rather it is merely a question of the communication terminal rarely being forgotten and the additional component concerned also not being forgotten. It is also not a question of whether the additional component has an advantage for the communication terminal itself. It is, for example, particularly as far as the humidity sensor is concerned, solely a question of whether a heating engineer, for example, can always measure the humidify of air in a room or in an air-conditioning unit or can check the humidity of the air in an office or an apartment. It is, in any case, not a question of whether the communication terminal itself is objectively affected advantageously by the present of the humidity sensor.

A known publication JP 61294417 A discloses a power supply control circuit exclusively for a display is known that, with the aid of a humidity sensor, switches the power supply for the display on or off depending on whether a humidity threshold value is exceeded or not. The purpose of this measure is to prevent electrolytical corrosion on the electrodes of the display. This known system does not, however, disclose, for example, whether or not the control circuit is processor-controlled (i.e., it could equally well be simply resistance-controlled). There is in any case no indication that the control circuit is a processor-based control.

Irrespective of the mode of operation of the known power supply control circuit, the power supply control circuit is also intended exclusively to monitor the humidity threshold value and to effect the switching on and off of the display supply voltage. No mention is made in the publication that the power supply control circuit is also intended to control the functions of a mobile communication terminal. It is merely that that, to protect the display electrodes against corrosion, the display supply voltage should be switched off if a humidity threshold value is exceeded.

From DATABASE WPI Section EI, Week 200228 Derwent Publications Ltd., London, GB; Class WO2, AN 2002-223571 XP002239759 & KR 2001 097 682 A (APPEAL TELECOM CO LTD), 8 Nov. 2001 (2001-11-08), a device with a humidity sensor for automatically switching off the power supply of a cellular telephone as soon as the measured humidity exceeds a predetermined value is known.

### SUMMARY

The present disclosure sets forth a mobile communication terminal, based upon a mobile communication terminal of the type specified in the background above, provided with technical measures for such a mobile communication terminal that mitigate or completely avoid the signs of corrosion on or in the mobile communication terminal.

An example of a disclosed mobile communication terminal includes a processor control for processor-based handling of associated functions. Additionally, the terminal includes a humidity sensor controlled by the processor-controlled and configured to detect humidity. The processor control is further configured to initiate at a predetermined time one of a complete or partial shut down of functional groups of the mobile communication terminal when humidity is detected by the humidity sensor.

### DETAILED DESCRIPTION OF THE PRESENT EXAMPLES

According to the presently disclosed mobile communication terminal, humidity sensors are provided on or in the mobile communication terminal, with the aid of which the processor control present in the mobile communication terminal detects any humidity in the mobile communication terminal. As a consequence of the humidity being detected, the processor control then prompts a complete or partial shutdown of functional components of the mobile communication terminal. Those functional components that are primarily affected by corrosion are particularly selected for partial shutdown of functional components. Another option is to switch off the device completely. In any case, when present humidity has been identified in the device, existing voltage differentials have to be minimized. The voltage differentials must be minimized at least to the extent that they become insignificant in terms of producing corrosion.

For example, when the functional components concerned are switched off, such voltage differentials disappear, and corrosion can no longer occur as a result of these voltage differentials. Without at least a sufficiently high voltage differential, no electrolysis can occur between two potential points concerned. The device, thus, remains corrosion-free. Trials have shown that immersed devices that are current-free remain free of corrosion damage for weeks.

The humidity sensors used for detecting humidity can be arranged, for example, at the contact points of the keypad and, if necessary, also at several other points in the mobile communication terminal. They can, for example, be arranged on a printed circuit board in the device. It is, in principle, conceivable for just one independent humidity sensor to be provided in total. This will apply where multiple humidity sensors cannot be provided for reasons of space.

The humidity sensors can be produced like a keypad meander, so they can be produced simultaneously with the meanders of the keypad. As a result, no further costs are incurred on the printed circuit board in relation to the device as a whole.

The detection of liquid in the mobile communication terminal itself is effected by software implemented inside the processor control of the mobile communication terminal. If, for example, liquid reaches one of the humidity sensors, frequencies or contact resistances, for example, can, depending on the type of humidity sensor and the associated circuit type, be altered by the liquid so markedly that an analysis can be carried out in this case by the processor control or else by a different control.

The analysis can, for example, result in an entry in the device logging file, so that it is even possible to check at a later time whether a detection of humidity has taken place at an earlier time. This can be of interest, for example, in cases such as those in which the mobile communication terminal is in active communication mode (e.g., in the transmission or receipt of an SMS (short message) or the handling of a communication call), while the humidity detector is reporting humidity in the mobile communication terminal. It is advantageous in this case to delay any measure to curtail corrosion until such time as the active status of the mobile communication terminal has ended. After the active status of the mobile communication terminal has ended, a check can then always be carried out to ascertain whether or not humidity has occurred in the mobile communication terminal, and an appropriate response to this can then still be carried out. The signs of corrosion are, in any case, significantly reduced.

It is further noted that, in a partial shutdown of functional components of the mobile communication terminal at least those functional components of the mobile communication terminal that are important for detecting humidity and for reactivating the whole device after drying of the mobile communication device has progressed sufficiently, remain activated. It is beneficial here that autonomous reactivation of the device is possible and that a user of the mobile communication terminal does not have to ensure explicitly that the mobile communication terminal is switched on again.

In another example, at least those functional components that remain active when humidity is detected are designed or laid out in such a way that the voltage differential prevailing between two existing electrically active potential points with a maximum spacing equal to or less than the spacing absolutely necessary for electrolysis is at most equal to or less than 1.2 volts. The benefit here is that prevention of corrosion is achieved without actually having to switch off fully the functional components concerned. The less comprehensively the mobile communication terminal has to be shut down, the more serviceable it remains even in the corrosion-curbing phase.

The lower the voltage differentials, the greater the probability that, given an otherwise unchanged geometry, no electrolysis will be set in motion by humidity penetrating the mobile communication terminal. Empirical observations suggest that the effects of preventing signs of corrosion are greatest in an initial reduction phase of the reduction of prevailing voltage differentials and are later not as great. In a hitherto conventional mobile communication terminal, a kind of threshold value for voltage differentials can be set (e.g., 0.9/0.8 volts), below which practically no electrolyzing effect continues to manifest itself. It is therefore possible to restrict voltages to this threshold value and to operate the mobile communication terminal, at least as far as possible, below this threshold value.

As already mentioned previously, it is beneficial if the detection of humidity that has penetrated can be stored in the memory of the mobile communication terminal. This is because activities of the mobile communication terminal that are still active can be first completed by the mobile communication terminal before the corrosion-curbing measures are then activated.

In another example, emergency call connections and/or other consciously desired connections, for example, can at least, in principle, still be effected. This does, of course, have its limits where, because the destruction of physical prerequisites by the corrosion is too far advanced, such desired connections are no longer possible at all.

Although preferred examples of the present apparatus have been disclosed for illustrative purposes, those of ordinary skill in the art will appreciate that the scope of this patent is not limited thereto. On the contrary, this patent covers all apparatus falling within the scope of the appended claims.

1-7. (canceled)

8. A mobile communication terminal comprising:
a processor control for processor-based handling of associated functions;
a humidity sensor controlled by the processor control and configured to detect humidity;
wherein the processor control is configured to initiate at a predetermined time one of a complete or partial shutdown of functional groups of the mobile communication terminal when humidity is detected by the humidity sensor.

9. A mobile communication terminal as defined in claim 8, wherein the processor control is further configured, in the event of a partial shutdown of the mobile communication terminal, to maintain in an active state at least functional components of the mobile communication terminal that are used to detect humidity and to reactivate the terminal.

10. A mobile communication terminal as defined in claim 9, wherein the functional components maintained in an active state in the event of a partial shutdown of the mobile communication terminal are configured such that a voltage differential between two electrically active potential points having a spacing at most equal to or less than that necessary for electrolysis to occur is equal to or less than 1.2 volts.

11. A mobile communication terminal as defined in claim 10, wherein the voltage differential is equal or less than 0.9 volts.

12. A mobile communication terminal as defined in claim 8, wherein the processor control is further configured to set the predetermined time for the initiation of partial or complete shutdown of the mobile communication terminal to occur immediately when humidity is detected.

13. A mobile communication terminal as defined in claim 8, wherein the processor control is further configured to set the predetermined time for the initiation of partial or complete shutdown of the mobile communication terminal to occur immediately after completion of an active action being currently performed by the mobile communication terminal.

14. A mobile communication terminal as defined in claim 8, wherein the processor control is further configured to maintain one or more of emergency call connections and desired connections after the humidity detector detects humidity.
